(19) United States
(12) Patent Application Publication
(10) Pub. No.: US 2021/0320822 A1
(43) Pub. Date: Oct. 14, 2021

(54) METHOD OF CHANNEL ESTIMATION USING DMRS WITH CROSS-POLARIZATION ANTENNA

(71) Applicant: NOKIA TECHNOLOGIES OY, Espoo (FI)

(72) Inventors: Bulin ZHANG, Branchburg, NJ (US); Jerry WANG, Marlboro, NJ (US)

(21) Appl. No.: 17/264,168

(22) PCT Filed: Jul. 30, 2018
(86) PCT No.: PCT/US2018/044413

§ 371 Date: Jan. 28, 2021

(51) Int. Cl. H04L 25/02; H04B 7/10; H04J 11/00; H04J 13/00

(52) U.S. Cl. CPC H04L 25/0224; H04B 7/10; H04B 7/0456; H04J 13/004; H04L 25/0204; H04J 11/0036

(57) ABSTRACT

An apparatus may include at least one processor and at least one memory including computer program code. The at least one memory and the computer program code can be configured to, with the at least one processor, cause the apparatus to at least apply at least one orthogonal cover code to at least a first antenna port and a second antenna port. The at least one memory and the computer program code can be further configured to, with the at least one processor, cause the apparatus to at least perform at least one rotation operation associated with at least one signal of the first antenna and the second antenna. The apparatus is caused to at least perform at least one channel estimation based upon the at least one signal of the first antenna and the second antenna.

### BACKGROUND

### Field

Certain embodiments may relate to wireless communication systems. For example, some embodiments may relate to channel estimation.

### Description of the Related Art

Channel estimation may be performed based upon at least one demodulation reference signal (DMRS) in a single user equipment (UE) transmission. Intra-cell and/or inter-UE interference may be treated as inter-cell interference without utilizing antenna polarization.

In 4G or 5G downlink transmission, UE-specific DMRS may be used to have minimum interference with each other, either by using different resource elements (RE) and/or by using different orthogonal cover codes (OCC). For example, FIGS. 1-3 illustrate an example of 4G/LTE which defines specific RE and OCC values for different antenna ports (AP) to use. For example, in the LTE DMRS design illustrated in FIGS. 1-3, for MU MIMO downlink transmissions, two user equipment may share the same RE and OCC, which may directly interfere with each other. The channel estimation obtained through DMRS may no longer be from the target UE only, but with components from other UE within the MU mode. As a result, additional errors may be created following data channel decoding. Despite a certain level of spatial separation between two UE in MU MIMO, the intra-cell and inter-UE interference may dominate interference for channel estimation using DMRS.

In particular, FIG. 1 illustrates an example of DMRS resource allocation and AP mapping defined in a LTE system, as shown at subframes 3, 4, 8, and 9. However, RE allocation for DMRS may be similar for other subframes. In addition, FIG. 2 illustrates various OCCs designed for different AP, as defined in LTE, such as the sequence w̅ₚ(i) for a normal cyclic prefix. FIG. 3 then illustrates AP assignments for downlink grants in LTE DCI format 3C. For example, for a 2 UE 2×2 MIMO assignment, 2 UE may share the same AP (RE) with difference sequences, such as n_{scid}; alternatively, for a 3 UE 2×2 MIMO assignment, 2 UE may share the same AP (RE) with the same sequence.

However, when MU MIMO is used, the DMRS used by various UE in the same cell may need to share the same RE and/or OCC, which may lead to higher interference with each other. Though different UE sharing the same RE may have certain level of spatial separation, the inter-UE interference may still affect channel estimation accuracy.

### SUMMARY

In accordance with some embodiments, a method may include applying, by user equipment, at least one orthogonal cover code to at least a first antenna port and a second antenna port. The method may further include performing, by the user equipment, at least one rotation operation associated with at least one signal of the first antenna and the second antenna. The method may further include performing, by the user equipment, at least one channel estimation based upon the at least one signal of the first antenna and the second antenna.

In accordance with some embodiments, an apparatus may include means for applying at least one orthogonal cover code to at least a first antenna port and a second antenna port. The apparatus may further include means for performing at least one rotation operation associated with at least one signal of the first antenna and the second antenna. The apparatus may further include means for performing at least one channel estimation based upon the at least one signal of the first antenna and the second antenna.

In accordance with some embodiments, an apparatus may include at least one processor and at least one memory including computer program code. The at least one memory and the computer program code can be configured to, with the at least one processor, cause the apparatus to at least apply at least one orthogonal cover code to at least a first antenna port and a second antenna port. The at least one memory and the computer program code can be further configured to, with the at least one processor, cause the apparatus to at least perform at least one rotation operation associated with at least one signal of the first antenna and the second antenna. The at least one memory and the computer program code can be further configured to, with the at least one processor, cause the apparatus to at least perform at least one channel estimation based upon the at least one signal of the first antenna and the second antenna.

In accordance with some embodiments, a non-transitory computer readable medium can be encoded with instructions that may, when executed in hardware, perform a method. The method may apply at least one orthogonal cover code to at least a first antenna port and a second antenna port. The method may further perform at least one rotation operation associated with at least one signal of the first antenna and the second antenna. The method may further perform at least one channel estimation based upon the at least one signal of the first antenna and the second antenna.

In accordance with some embodiments, a computer program product may perform a method. The method may apply at least one orthogonal cover code to at least a first antenna port and a second antenna port. The method may further perform at least one rotation operation associated with at least one signal of the first antenna and the second antenna. The method may further perform at least one channel estimation based upon the at least one signal of the first antenna and the second antenna.

In accordance with some embodiments, an apparatus may include circuitry configured to apply at least one orthogonal cover code to at least a first antenna port and a second antenna port. The circuitry may further perform at least one rotation operation associated with at least one signal of the first antenna and the second antenna. The circuitry may further perform at least one channel estimation based upon the at least one signal of the first antenna and the second antenna.

In accordance with some embodiments, a method may include receiving, by a data decoding entity, a matrix associated with a data channel decoder with at least one angle from user equipment. The method may further include performing, by the data decoding entity, at least one rotation operation based upon received data with a shared angle. The method may further include performing, by the data decoding entity, data decoding.

In accordance with some embodiments, an apparatus may include means for receiving a matrix associated with a data channel decoder with at least one angle from user equipment. The apparatus may further include means for performing at least one rotation operation based upon received data with a shared angle. The apparatus may further include means for performing data decoding.

In accordance with some embodiments, an apparatus may include at least one processor and at least one memory including computer program code. The at least one memory and the computer program code can be configured to, with the at least one processor, cause the apparatus to at least apply at least one orthogonal cover code to at least a first antenna port and a second antenna port. The at least one memory and the computer program code can be further configured to, with the at least one processor, cause the apparatus to at least perform at least one rotation operation associated with at least one signal of the first antenna and the second antenna. The at least one memory and the computer program code can be further configured to, with the at least one processor, cause the apparatus to at least perform at least one channel estimation based upon the at least one signal of the first antenna and the second antenna.

In accordance with some embodiments, a non-transitory computer readable medium can be encoded with instructions that may, when executed in hardware, perform a method. The method may apply at least one orthogonal cover code to at least a first antenna port and a second antenna port. The method may further perform at least one rotation operation associated with at least one signal of the first antenna and the second antenna. The method may further perform at least one channel estimation based upon the at least one signal of the first antenna and the second antenna.

In accordance with some embodiments, a computer program product may perform a method. The method may apply at least one orthogonal cover code to at least a first antenna port and a second antenna port. The method may further perform at least one rotation operation associated with at least one signal of the first antenna and the second antenna. The method may further perform at least one channel estimation based upon the at least one signal of the first antenna and the second antenna.

In accordance with some embodiments, an apparatus may include circuitry configured to apply at least one orthogonal cover code to at least a first antenna port and a second antenna port. The circuitry may further perform at least one rotation operation associated with at least one signal of the first antenna and the second antenna. The circuitry may further perform at least one channel estimation based upon the at least one signal of the first antenna and the second antenna.

### BRIEF DESCRIPTION OF THE DRAWINGS

For proper understanding of this disclosure, reference should be made to the accompanying drawings, wherein:

FIG. 1 illustrates DMRS resource allocation and antenna port mapping as defined in LTE.

FIG. 2 illustrates different OCC designed for different antenna ports as defined in LTE.

FIG. 3 illustrates AP assignments for downlink grants in LTE DCI Format 3C.

FIG. 4a illustrates an example of a 2-antenna channel model according to some embodiments.

FIG. 4b illustrates an example of a 2-antenna polarization model according to some embodiments.

FIGS. 5a-c illustrate channel estimation with cross-polarization antenna according to some embodiments.

FIG. 6 illustrates an example of a transmitter and receiver being aligned according to some embodiments.

FIG. 7 illustrates a transmit and receiver operation after AP switch according to some embodiments.

FIG. 8 illustrates a downlink channel estimation at a UE.

FIG. 9 illustrates an interference reduction rotation operation according to some embodiments.

FIG. 10 illustrates a rotation angle estimation according to some embodiments.

FIG. 11 illustrates a rotation operation with estimated angle Φ according to some embodiments.

FIG. 12 illustrates a comparison of C/I before and after a rotation operation according to some embodiments.

FIG. 13 illustrates an example of a method performed by user equipment according to certain embodiments.

FIG. 14 illustrates another example of a method performed by a data decoding entity according to certain embodiments.

FIG. 15 illustrates an example of a system according to certain embodiments.

### DETAILED DESCRIPTION

Certain embodiments described herein may reduce the co-channel interference from MU MIMO transmission on DMRS, resulting in better channel estimation for improving data channel decoding. This may be achieved by using cross-polarization antenna for both transmitters and receivers, and performing an additional rotation operation on a received DMRS signal. Furthermore, certain embodiments may improve overall channel quality and achieve higher throughput for MU MIMO transmission. Certain embodiments are, therefore, directed to improvements in computer-related technology, specifically, by conserving network resources and reducing power consumption of data decoding entities and/or user equipment located within the network.

Between 2 access points of the same user equipment, DMRS may use different OCC, and may be orthogonal. Thus, certain embodiments discussed herein may consider only one access point. However, for embodiments which have the same mapping between logic APs and Physical APs, UE1 and UE2 may transmit DMRS signals with the same RE and polarization, with no way to separate the interference from the signal.

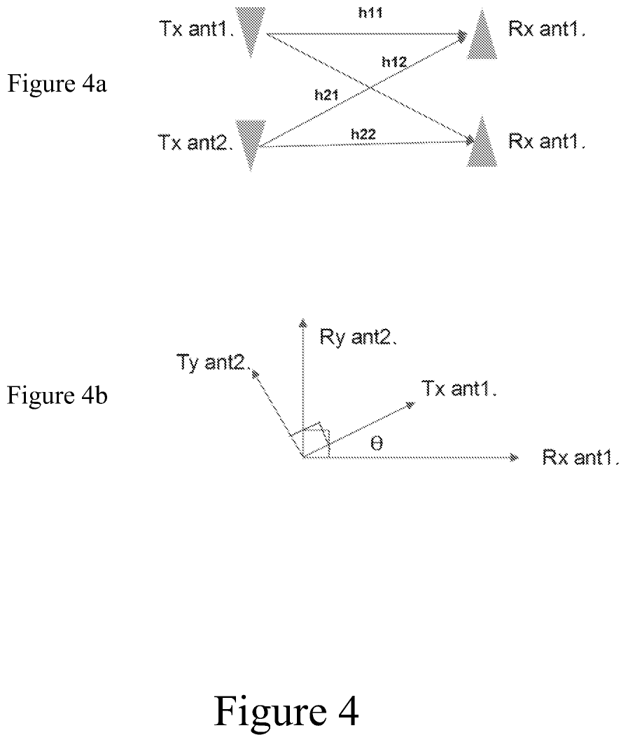

As shown in FIG. 4, a 2-antenna channel model may show transmissions from Tx antenna 1 and Tx antenna to Rx antenna 1 and Rx antenna 2, showing the switched mapping between physical and logical AP for two user equipment. In particular, with this configuration, the signals from UE1, and interference from UE2, is transmitted using two different physical antenna with orthogonal polarization.

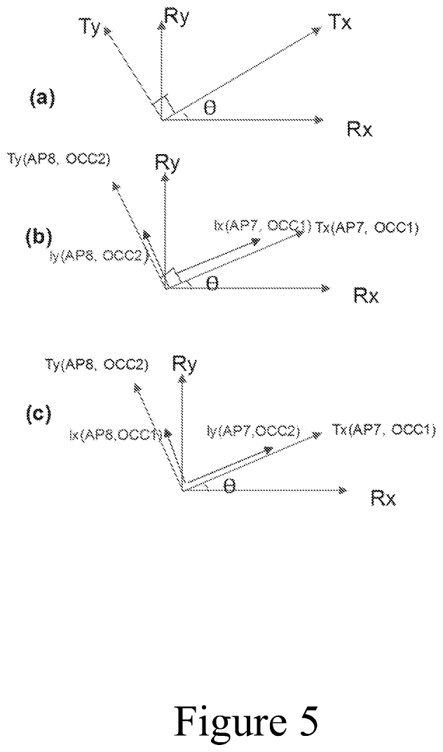

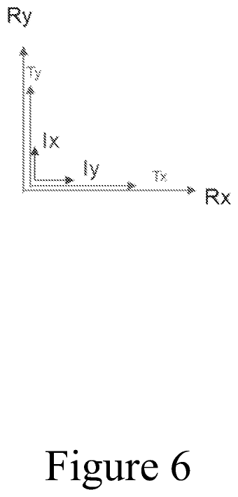

With respect to FIG. 5, for a signal UE transmission, AP 7 may be mapped to Tx, and AP 8 may be mapped to Ty. DMRS on AP7 and AP8 may have OCC, causing interference to be cancelled by the other. During MU MIMO, 2 UE transmissions with the same sequence will directly interfere at the same RE without OCC. As shown in FIG. 5b, Ix may indicate the interference from UE2 to UE1 due to beamforming overlap. The interference level is determined by spatial separation in beamforming. With the same OCC and polarization direction, the interference may not be eliminated, and may impact the accuracy of the channel estimation. As a result, mapping between a physical AP and logical AP for two UE may be switched, as illustrated in FIG. 6. As shown in FIG. 5c, after switching, the interference and signal on the same AP may have different OCC.

FIG. 6 then illustrates an example of transmitters and receivers being perfectly aligned. In this example, UE2 to UE1 interference may be cancelled by XPD, where Tx may use OCC [+1,+1,+1,+1], while Ty may use [+1,−1,+1,−1] for UE1. In contrast, for UE 2, Ix may use OCC [+1,+1,+1,+1], and Ty may use [+1,−1,+1,−1]. When the receiver and transmitter polarization directions are aligned, Rx may only receive Tx and Ty, while Ty and Ix are dropped by XPD (cross-polarization discrimination), which could be in the range of 20-30 dB.

Because Tx and Ty are using different OCC, Ty may be cancelled by applying OCC. This may provide an isolated DMRS signal Tx for UE1 channel estimation, with the same result for Ty. When the receiver and transmitter polarizations are not aligned, Rx may have polarization projections for both Ix and Ty. As a result, projections from Ty may have the same OCC as the signal Tx which may not be cancelled.

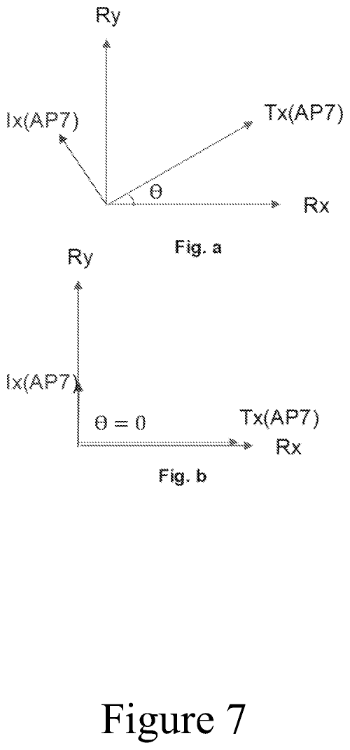

FIG. 7 illustrates some embodiments of signal rotation operations. In particular, signals may be received from UE1 without interference from UE2 based upon the angle between the receiver and transmitter polarization. For example, if a receiver and transmitter are aligned, such as where 0=0, as shown in FIG. 7a, interference from UE2 may be completely suppressed by cross-polarization discrimination (XPD), which may be in the range of 20-30 dB.

Where interference is received from another UE is transmitted on a different physical AP of different polarization but with the same OCC, the receiver signal at UE2 may be denoted by Rx=h11*cos [symbol] *Tx−h21*sin [symbol] *Ix and Ry=h12*sin [symbol] *Tx−h22*cos [symbol] *Ix, where h11 is channel coefficient from Tx to Rx before polarization projection, cos [symbol] is the polarization projection, and h21 is from Ix to Rx. A general expression of Rx and Ry, where h11=h11*cos [symbol] , may be denoted by Rx=h11*Tx−h21*Ix and Ry=h12*Tx+h22*Ix. For channel estimation with AP7 at the Rx, the receiver side may need to derive the values for h11 and h12. With AP8 at Ry, the receiver side may need to derive h21 and h22, where the full H matrix may be used for data channel decoding.

The ratio of C/I may be dependent upon [symbol] . With a small enough value of [symbol] , the interference h21*sin [symbol] *Ix may be small as well so that h11 may be estimated more accurately. In some embodiments, the estimation of h21 may be less accurate with a lower value of C/I. In certain embodiments, where [symbol] =0, the h12 estimation may be due to interference, which may be inaccurate.

In some embodiments, it may not be possible to obtain an exact value of [symbol] angle. Thus, an angle Φ may be obtained using the received signal strength on two AP after applying OCC, and by performing the rotation operation using Φ instead of [symbol] , performance may be improved.

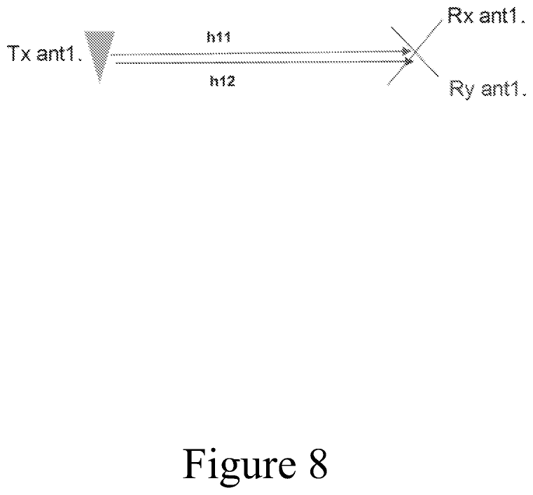

As illustrated in FIG. 8, two cross-polarization receivers at UE may be near or adjacent to each other, resulting in channel propagation from the same transmitter to both of the receiver antennas before polarization projection to be close, such as h11 and h12 being approximate.

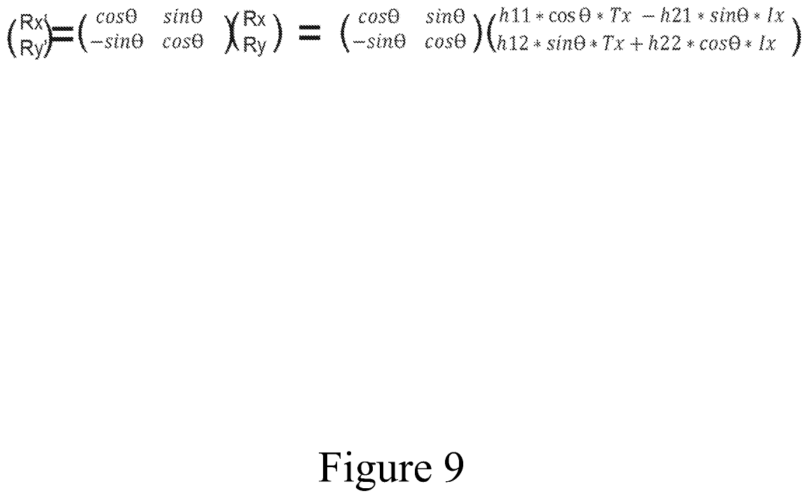

FIG. 9 illustrates an interference reduction rotation operation. in some embodiments, Rx′=h11*cos² [symbol] *Tx+h12*sin 2 [symbol] *Tx+sin [symbol] *cos [symbol] *(h22−h21)*Ix, and Ry′=sin [symbol] *cos [symbol] *(h12−h11)Tx+h22*cos 2*Ix+h21*sin² [symbol] *Ix. In contrast to FIG. 7, h11 and h12, and h21 and h22, may be close approximations. Thus, Rx′ may be estimated as h11*Tx, and Ry′ may be estimated as h22*Ix. Following this calculation, Rx′ may only have a Tx component, with no interference, and may be used to estimate h11. In some embodiments, matrix H may be obtained as h11=h11*cos [symbol] and h12=h11*cos [symbol] .

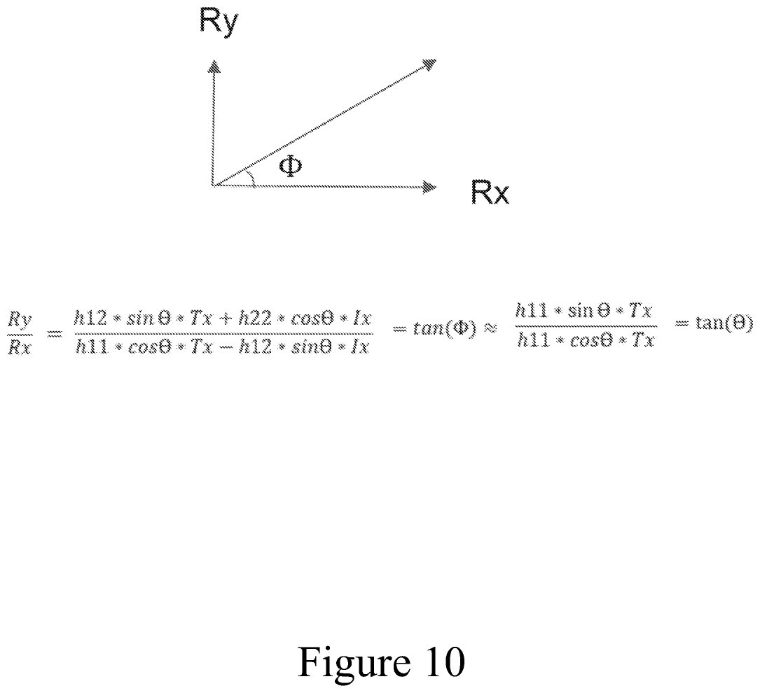

FIG. 10 illustrates a rotation operation using an estimated angle θ. For multiple UE MIMO transmission, h11*Tx>>h22*Ix. In some embodiments, the signal received from Rx and Ry may be used to estimate the angle shown in FIG. 10., where h11 and h12, and h21 and h22, may be close approximations.

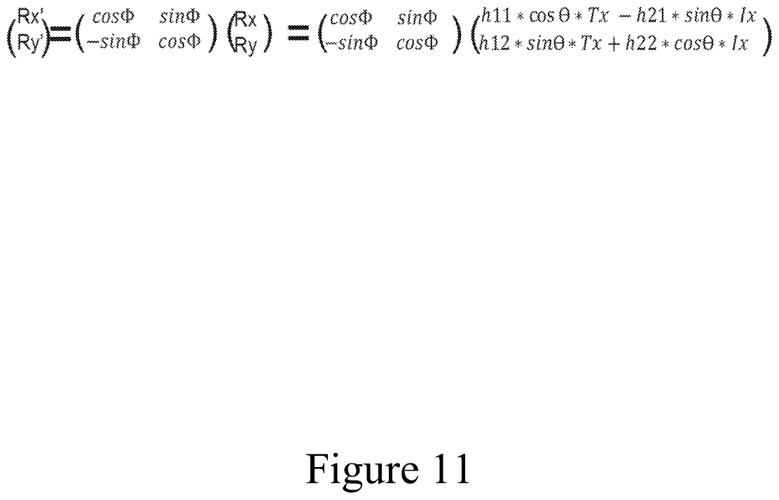

FIG. 11 illustrates how Rx′ and Ry′ may be determined. In addition, Rx′ may be determined by [h11*cos [symbol] *cos Φ+h12*sin [symbol] *sin Φ] *Tx+[sin [symbol] *cos [symbol] *h22−sin [symbol] *cos [symbol] *h21] *Ix, and Ry′ may be determined by [−h11*sin Φ*cos [symbol] +h12*cos [symbol] *sin [symbol] ] *Tx+[h21*sin [symbol] *sin [symbol] +h22*cos [symbol] *cos Φ] *Ix. In addition, h11=h12, and h21=h22, Rx′ may be determined by h11*Tx*cos(Φ− [symbol] )+h22*Ix*sin(Φ− [symbol] ), and Ry′ may be determined by h11*Tx*sin(Φ− [symbol] )+h22*Ix*cos(Φ− [symbol] ). Thus, C/I of Rx′ may equal (h11*Tx)/(h22*Ix)*cot(Φ− [symbol] ), where (h11*Tx)/(h22*Ix) is determined by spatial separation of MU transmission.

Following the rotation operation, the following equations may be applied: Rx=h11*cos [symbol] *Tx−h21*sin [symbol] *Ix and Ry=h12*sin [symbol] *Tx+h22*cos [symbol] *Ix. Where h11=h12 and h21=h22, α and γ may be used, where tan(α)=(h22*Ix)/(h11*Tx) and γ=√((h11*Tx)²+(h22*Ix)²). Then, Rx=(cos α*cos [symbol] −sin α*sin [symbol] )*γ=cos(α+ [symbol] )*γ, and Ry=(cos α *sin [symbol] −sin α*cos [symbol] *γ=sin(α+ [symbol] )*γ. Thus, Ry/Rx=tan(α+ [symbol] ), and tan(Φ)=Ry/Rx. As a result, tan(Φ)=tan(α+β), and 1=α+ [symbol] . Then, cot(Φ− [symbol] )=cot(α)=(h11*Tx)/(h22*Ix).

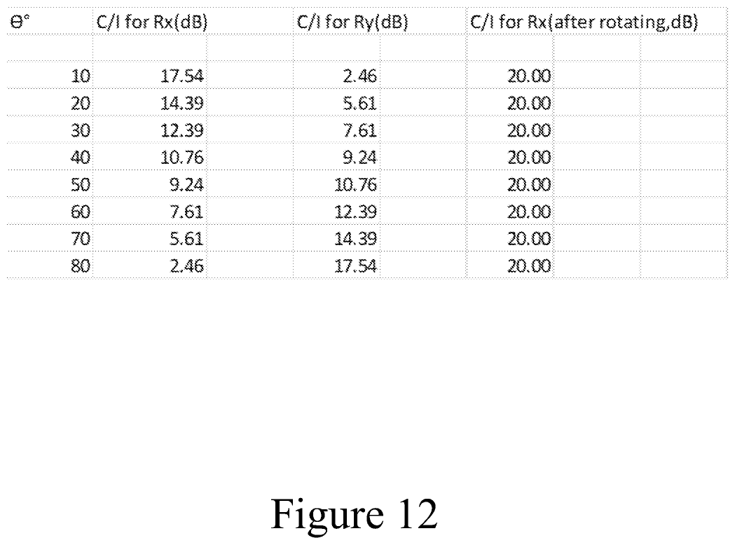

C/I of Rx′ may then be denoted as C/I=(h11*Tx)/(h22*Ix)*cot(Φ− [symbol] )=(h11*Tx)/(h22*Ix)². FIG. 12 illustrates various comparisons of values of C/I before and after the rotation operation.

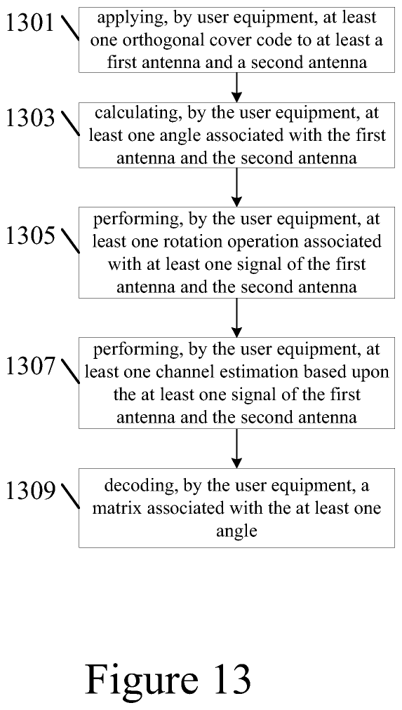

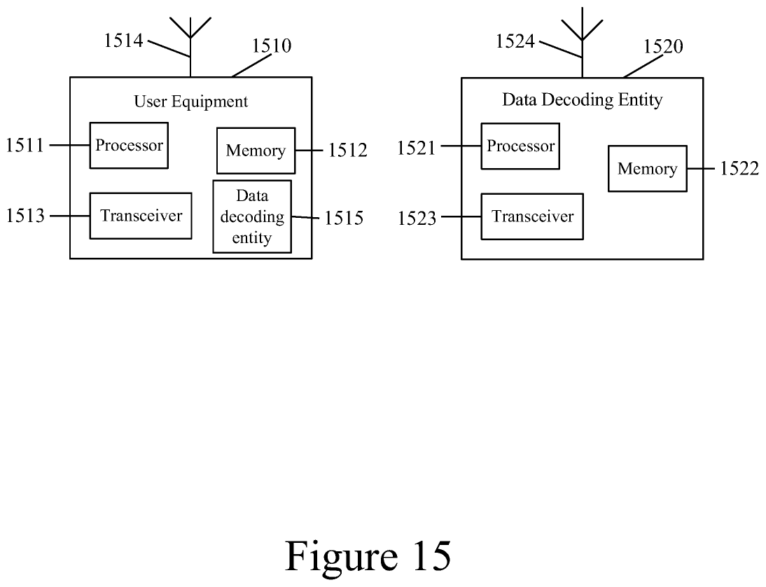

FIG. 13 illustrates an example of a method performed by user equipment, such as user equipment 1510 in FIG. 15. In step 1301, the user equipment may apply at least one orthogonal cover code to at least two antenna ports. In step 1303, the user equipment may calculate at least one angle associated with a first antenna and a second antenna. In step 1305, the user equipment may perform at least one rotation operation associated with at least one signal of the first antenna and the second antenna. In step 1307, the user equipment may perform at least one channel estimation based upon the at least one signal of the first antenna and the second antenna. In step 1309, the user equipment may send a matrix to a data channel decoder with at least one angle, such as data decoding entity 1520 in FIG. 15.

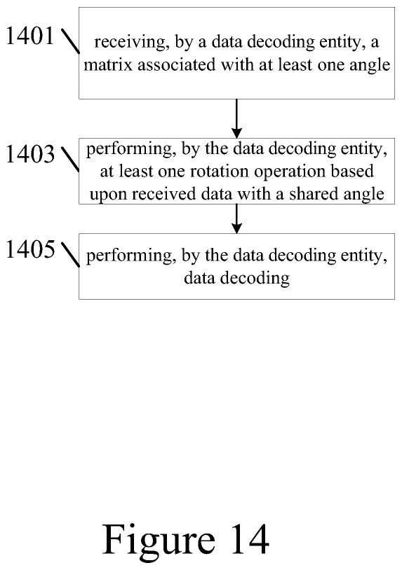

FIG. 14 illustrates an example of a method performed by a data decoding entity, such as data decoding entity 1520 in FIG. 15. In step 1401, the data decoding entity may receive a matrix associated with a data channel decoder with at least one angle from user equipment. In step 1403, the data decoding entity may perform at least one rotation operation based upon received data with a shared angle. In step 1405, the data decoding entity may perform data decoding.

FIG. 15 illustrates an example of a system according to certain embodiments. In one embodiment, a system may include multiple devices, such as, for example, user equipment 1510 and/or data decoding entity 1520.

User equipment 1510 may include one or more of a mobile device, such as a mobile phone, smart phone, personal digital assistant (PDA), tablet, or portable media player, digital camera, pocket video camera, video game console, navigation unit, such as a global positioning system (GPS) device, desktop or laptop computer, single-location device, such as a sensor or smart meter, or any combination thereof. User equipment 1510 may also include a decoding

Data decoding entity 1520 may be one or more of a base station, such as an evolved node B (eNB) or 5G or New Radio node B (gNB), a serving gateway, a server, and/or any other access node or combination thereof. Furthermore, user equipment 1510 and/or data decoding entity 1520 may be one or more of a citizens broadband radio service device (CBSD).

One or more of these devices may include at least one processor, respectively indicated as 1511 and 1521. Processors 1511 and 1521 may be embodied by any computational or data processing device, such as a central processing unit (CPU), application specific integrated circuit (ASIC), or comparable device. The processors may be implemented as a single controller, or a plurality of controllers or processors.

At least one memory may be provided in one or more of devices indicated at 1512 and 1522. The memory may be fixed or removable. The memory may include computer program instructions or computer code contained therein. Memories 1512 and 1522 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate from the one or more processors. Furthermore, the computer program instructions stored in the memory and which may be processed by the processors may be any suitable form of computer program code, for example, a compiled or interpreted computer program written in any suitable programming language. Memory may be removable or non-removable.

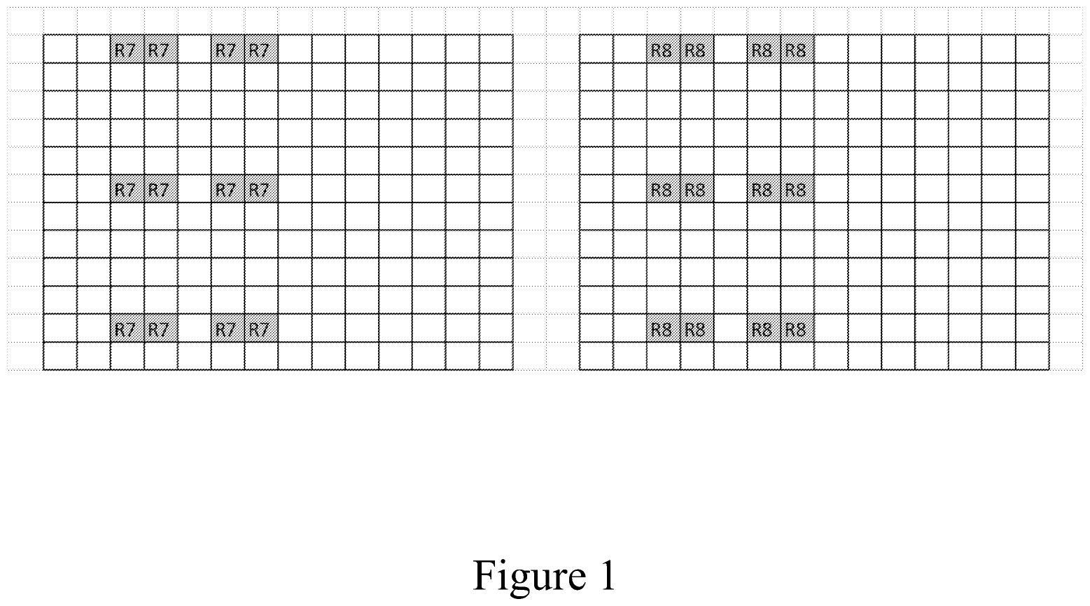

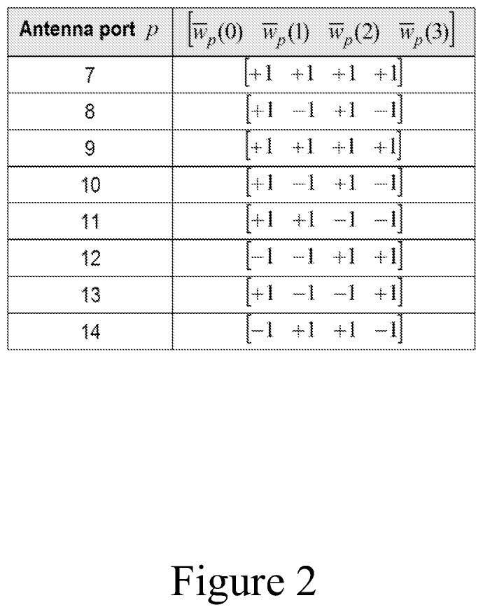

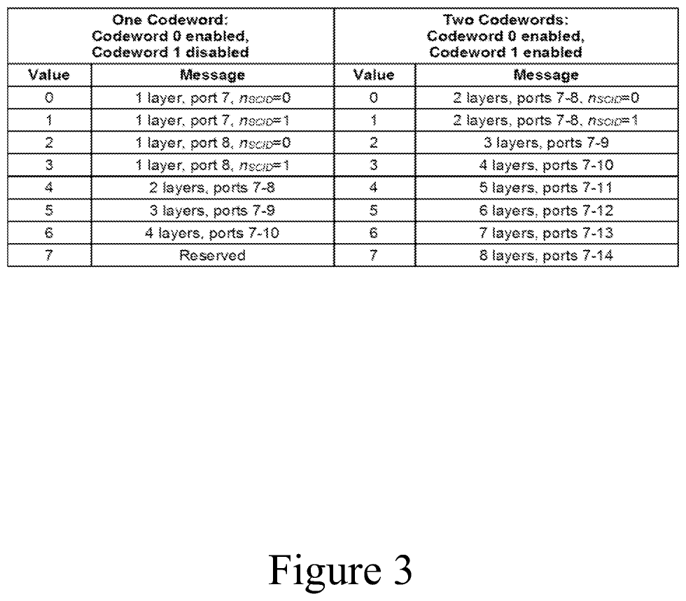

Processors 1511 and 1521 and memories 1512 and 1522 or a subset thereof, may be configured to provide means corresponding to the various blocks of FIGS. 1-14. Although not shown, the devices may also include positioning hardware, such as GPS or micro electrical mechanical system (MEMS) hardware, which may be used to determine a location of the device. Other sensors are also permitted and may be included to determine location, elevation, orientation, and so forth, such as barometers, compasses, and the like.

As shown in FIG. 15, transceivers 1513 and 1523 may be provided, and one or more devices may also include at least one antenna, respectively illustrated as 1514 and 1524. The device may have many antennas, such as an array of antennas configured for multiple input multiple output (MIMO) communications, or multiple antennas for multiple radio access technologies. Other configurations of these devices, for example, may be provided. Transceivers 1513 and 1523 may be a transmitter, a receiver, or both a transmitter and a receiver, or a unit or device that may be configured both for transmission and reception.

The memory and the computer program instructions may be configured, with the processor for the particular device, to cause a hardware apparatus such as user equipment to perform any of the processes described below (see, for example, FIGS. 1-14). Therefore, in certain embodiments, a non-transitory computer-readable medium may be encoded with computer instructions that, when executed in hardware, perform a process such as one of the processes described herein. Alternatively, certain embodiments may be performed entirely in hardware.

In certain embodiments, an apparatus may include circuitry configured to perform any of the processes or functions illustrated in FIGS. 1-14. For example, circuitry may be hardware-only circuit implementations, such as analog and/or digital circuitry. In another example, circuitry may be a combination of hardware circuits and software, such as a combination of analog and/or digital hardware circuit(s) with software or firmware, and/or any portions of hardware processor(s) with software (including digital signal processor(s)), software, and at least one memory that work together to cause an apparatus to perform various processes or functions. In yet another example, circuitry may be hardware circuit(s) and or processor(s), such as a microprocessor(s) or a portion of a microprocessor(s), that include software, such as firmware for operation. Software in circuitry may not be present when it is not needed for the operation of the hardware.

The features, structures, or characteristics of certain embodiments described throughout this specification may be combined in any suitable manner in one or more embodiments. For example, the usage of the phrases “certain embodiments,” “some embodiments,” “other embodiments,” or other similar language, throughout this specification refers to the fact that a particular feature, structure, or characteristic described in connection with the embodiment may be included in at least one embodiment of the present invention. Thus, appearance of the phrases “in certain embodiments,” “in some embodiments,” “in other embodiments,” or other similar language, throughout this specification does not necessarily refer to the same group of embodiments, and the described features, structures, or characteristics may be combined in any suitable manner in one or more embodiments.

One having ordinary skill in the art will readily understand that certain embodiments discussed above may be practiced with steps in a different order, and/or with hardware elements in configurations which are different than those which are disclosed. Therefore, it would be apparent to those of skill in the art that certain modifications, variations, and alternative constructions would be apparent, while remaining within the spirit and scope of the invention. In order to determine the metes and bounds of the invention, therefore, reference should be made to the appended claims.

Partial Glossary

3 GPP 3rd Generation Partnership Project

5G 5th Generation Wireless System

AP Antenna Port

DMRS Demodulation Reference Signal

eNB evolved Node B

gNB Next Generation Node B

LTE Long Term Evolution

MIMO Multiple Input Multiple Output

MU Multi-user

NE Network Entity

OCC Orthogonal Cover Code

RS Reference Signal

UE User Equipment

XPD Cross-polarization Discrimination

The invention claimed is:

1. An apparatus, comprising:
at least one processor; and
at least one memory including computer program code,
wherein the at least one memory and the computer program code are configured to, with the at least one processor, cause the apparatus to:
apply at least one orthogonal cover code to at least a first antenna port and a second antenna port;
perform at least one rotation operation associated with at least one signal of the first antenna and the second antenna; and
perform at least one channel estimation based upon the at least one signal of the first antenna and the second antenna.

2. The apparatus according to claim 1, wherein the at least one memory and the computer program code are further configured to, with the at least one processor, cause the apparatus to:
calculate at least one angle associated with the first antenna and the second antenna.

3. The apparatus according to claim 1,
wherein the at least one memory and the computer program code are further configured to, with the at least one processor, cause the apparatus to:
send a matrix to a data channel decoder with at least one angle to at least one data decoding entity.

4. An apparatus, comprising:
at least one processor; and
at least one memory including computer program code,
wherein the at least one memory and the computer program code are configured to, with the at least one processor, cause the apparatus to:
receive a matrix associated with a data channel decoder with at least one angle from user equipment;
perform at least one rotation operation based upon received data with a shared angle; and
perform data decoding.

5. A method, comprising:
applying, by user equipment, at least one orthogonal cover code to at least a first antenna port and a second antenna port;
performing, by the user equipment, at least one rotation operation associated with at least one signal of the first antenna and the second antenna; and
performing, by the user equipment, at least one channel estimation based upon the at least one signal of the first antenna and the second antenna.

6. The method according to claim 5, further comprising:
calculating, by the user equipment, at least one angle associated with the first antenna and the second antenna.

7. The method according to claim 5, further comprising:
sending, by the user equipment, a matrix to a data channel decoder with at least one angle to at least one data decoding entity.

8. A method, comprising:
receiving, by a data decoding entity, a matrix associated with a data channel decoder with at least one angle from user equipment;
performing, by the data decoding entity, at least one rotation operation based upon received data with a shared angle; and
performing, by the data decoding entity, data decoding.

9. A computer program embodied on a non-transitory computer-readable medium, said computer program comprising instructions that, when executed in hardware, cause the hardware to perform the method according to claim 5.

10. (canceled)

11. An apparatus comprising circuitry configured to cause the apparatus to perform the method according to claim 5.

12. (canceled)

13. A computer program embodied on a non-transitory computer-readable medium, said computer program comprising instructions that, when executed in hardware, cause the hardware to perform the method according to claim 8.

14. An apparatus comprising circuitry configured to cause the apparatus to perform the method according to claim 8.
